(19) United States
(12) Patent Application Publication
(10) Pub. No.: US 2025/0061440 A1
(43) Pub. Date: Feb. 20, 2025

(54) IN-VEHICLE PAYMENT SYSTEM AND METHOD

(71) Applicant: Aisin Corporation, Kariya-Shi (JP)

(72) Inventors: Patrick M Tirado-Egas, Mckinney, TX (US); Joshua Austin Cook, Mansfield, TX (US); Kolbey M Araujo, Aubrey, TX (US)

(21) Appl. No.: 18/450,609

(22) Filed: Aug. 16, 2023

(51) Int. Cl. G06Q 20/32; B60W 40/105; B60W 50/14; H04W 4/021

(52) U.S. Cl. CPC G06Q 20/3224; B60W 40/105; B60W 50/14; H04W 4/021; B60W 2050/146

(57) ABSTRACT

Disclosed are systems and methods for in-vehicle payments. In one example, a system for providing in-vehicle payments includes a processor and a memory in communication with the processor. The memory includes instructions that cause the processor, in response to determining when a vehicle enters a specialized region within a geo-fenced location and a vehicle operating change state signal, to transmit an instruction to provide a location confirmation interface for utilization by an occupant of the vehicle. Additionally, the instructions also cause the processor, in response to a location confirmation signal indicating that the occupant has confirmed the location of the vehicle using the location confirmation interface, to transmit another instruction to provide a payment confirmation interface for utilization by the occupant. The instructions may also be able to configure the processor to process payments.

### TECHNICAL FIELD

The subject matter described herein relates, in general, to systems and methods for providing in-vehicle payments, wherein payments for goods and/or services are performed through vehicle occupant interaction with one or more systems mounted within the vehicle.

### BACKGROUND

The background description provided is to present the context of the disclosure generally. Work of the inventor, to the extent it may be described in this background section, and aspects of the description that may not otherwise qualify as prior art at the time of filing, are neither expressly nor impliedly admitted as prior art against the present technology.

Current systems and methods for paying for services that involve a vehicle, such as refueling/recharging, parking, goods delivery, etc., typically involve having an occupant of a vehicle interact with a non-vehicle system. For example, when refueling a vehicle, the occupant must exit the vehicle and present payment at the fuel pump or inside the refueling station. Still, other systems require that the occupant interacts with their mobile device to provide payment via a mobile device application.

### SUMMARY

This section generally summarizes the disclosure and is not a comprehensive explanation of its full scope or all its features.

In one embodiment, a system for providing in-vehicle payments includes a processor and a memory in communication with the processor. The memory includes instructions that cause the processor to determine when a vehicle enters a specialized region within a geo-fenced location and when an appropriate vehicle operating change state signal (e.g., placing the vehicle in park) is received. When this occurs, the processor transmits an instruction to provide a location confirmation interface for utilization by an occupant of the vehicle. The instructions also cause the processor, in response to a location confirmation signal, to transmit another instruction to provide a payment confirmation interface for utilization by the occupant. The instructions may also be able to configure the processor to process payments. For example, the instructions can also cause the processor to initiate a payment facilitator server that electronically collects payment under an authorized payment vendor in response to receiving a payment authorization from the vehicle indicating that the occupant has authorized payment using the payment confirmation interface.

In another embodiment, a related method includes the steps of (a) in response to determining when a vehicle enters a specialized region within a geo-fenced location and a vehicle operating change state signal, transmitting a first instruction to provide a location confirmation interface for utilization by an occupant of the vehicle, and (b) in response to a location confirmation signal indicating that the occupant has confirmed a location of the vehicle using the location confirmation interface, transmitting a second instruction to provide a payment confirmation interface for utilization by the occupant of the vehicle. Like before, the related method may also be able to process payments.

In yet another embodiment, a non-transitory computer-readable medium including instructions that, when executed by a processor, cause the processor to, in response to determining when a vehicle enters a specialized region within a geo-fenced location and receiving a vehicle operating change state signal, transmit an instruction to provide a location confirmation interface for utilization by an occupant of the vehicle. Additionally, the instructions also cause the processor, in response to a location confirmation signal indicating that the occupant has confirmed the location of the vehicle using the location confirmation interface, to transmit another instruction to provide a payment confirmation interface for utilization by the occupant. Again, the instructions may also be able to configure the processor to process payments.

Further areas of applicability and various methods of enhancing the disclosed technology will become apparent from the description provided. The description and specific examples in this summary are intended for illustration only and not to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements, or multiple elements may be designed as one element. In some embodiments, an element shown as an internal component of another element may be implemented as an external component and vice versa. Furthermore, elements may not be drawn to scale.

FIG. 1 illustrates a block diagram of a system that enables in-vehicle payments.

FIG. 2 illustrates one example of when in-vehicle payments may be utilized provided by the system of FIG. 1.

FIGS. 3A-3G illustrate examples of a user interface at different stages an occupant of the vehicle would utilize for in-vehicle payments.

FIG. 4 illustrates a method wherein a vehicle capable of offering in-vehicle payments provides location information to a centralized server based on the speed of the vehicle.

FIG. 5 illustrates a method from the perspective of the centralized server for providing in-vehicle payment services to a vehicle.

### DETAILED DESCRIPTION

Described are systems and methods related to providing in-vehicle payments for occupants of vehicles. In one example, an in-vehicle payment service interface may be provided via the head unit of the vehicle so that the occupant can purchase goods and services via that interface. The in-vehicle payment service is enabled by using the precise location of the vehicle as well as a change in a vehicle operating state, such as changing the vehicle from drive to park.

For example, where the service involves refueling a vehicle, a vehicle pulls up to a refueling pump. The vehicle may provide the vehicle's precise location to a centralized server as well as any change in vehicle state, such as shifting the vehicle to park. When the centralized server determines that the vehicle has entered a specialized region, such as directly in front of a refueling pump, and that the vehicle has been shifted into park, the centralized server can transmit an instruction to the vehicle to provide location confirmation information for utilization by the occupant of the vehicle to confirm the location of the vehicle, such as which pump the vehicle is parked in front of. Upon receiving location confirmation, the centralized server can send another instruction to the vehicle to provide a payment confirmation interface for the occupant. Upon confirming payment by the occupant, services can then be rendered.

As such, the in-vehicle payment system utilizes the precise location of the vehicle as well as a change in the vehicle's operating state to determine when to provide the appropriate interface for an occupant to utilize. This greatly simplifies the number of steps the occupant needs to perform to pay for goods or services, increasing the convenience to the occupant and increasing the likelihood that the occupant would utilize the in-vehicle payment system, as opposed to more cumbersome and traditional approaches.

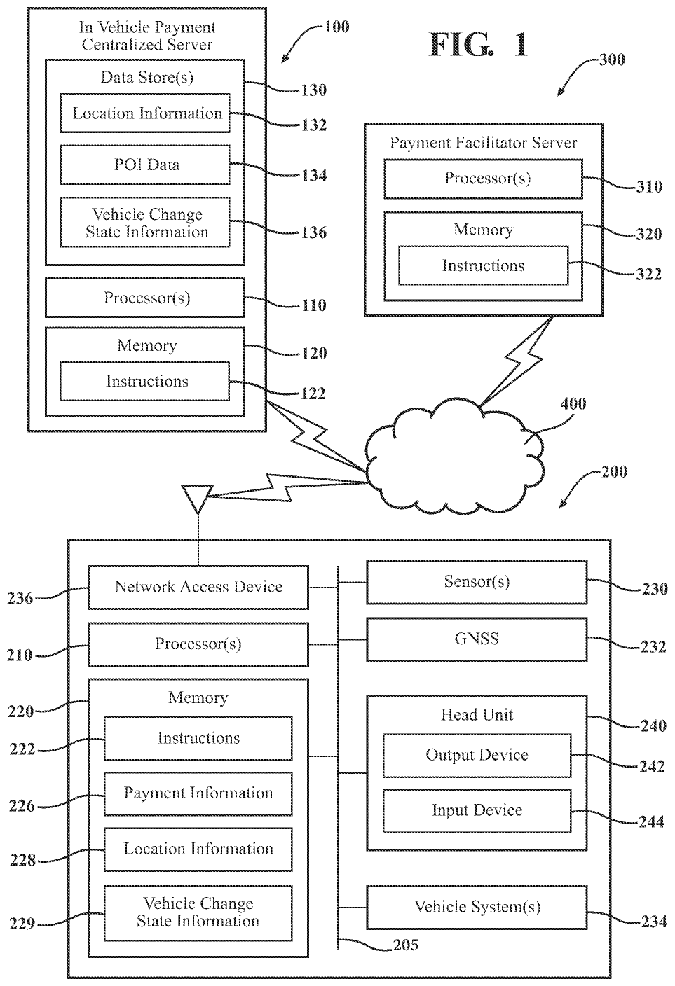

Referring to FIG. 1, illustrated is one example of an architecture that enables in-vehicle payment services. This example shows an in-vehicle payment centralized server 100, a vehicle 200, and a payment facilitator server 300 that can communicate with each other via a network 400. The network 400 may be a distributed network, such as the Internet.

It should be understood that the architecture, number of components, and the function of these different components can change from application to application and that this is just one example. Broadly, the in-vehicle payment centralized server 100 receives vehicle location information and change of operating state information from the vehicle 200 and, based on this information, instructs one or more systems of the vehicle 200 to provide the appropriate interface for an occupant to enable in-vehicle payments. Once authorized by the occupant, the in-vehicle payment centralized server 100 can communicate with the payment facilitator server 300 to arrange payments to the appropriate merchant.

As to the specific details of the different components of FIG. 1, the in-vehicle payment centralized server 100 may include one or more processor(s) 110. Accordingly, the processor(s) 110 may be a part of the in-vehicle payment centralized server 100, or the in-vehicle payment centralized server 100 may access the processor(s) 110 through a data bus or another communication path. In one or more embodiments, the processor(s) 110 is an application-specific integrated circuit configured to implement functions associated with instructions 122 that may be stored within a memory 120 in communication with the processor(s) 110. In general, the processor(s) 110 is an electronic processor, such as a microprocessor, capable of performing various functions described herein.

In one embodiment, the in-vehicle payment centralized server 100 includes a memory 120 that stores instructions 122. The memory 120 may be a random-access memory (RAM), read-only memory (ROM), a hard disk drive, a flash memory, or other suitable memory for storing instructions 122. The instructions 122 are, for example, computer-readable instructions that, when executed by the processor(s) 110, cause the processor(s) 110 to perform the various functions disclosed herein.

Furthermore, in one embodiment, the in-vehicle payment centralized server 100 includes one or more data store(s) 130. The data store(s) 130 is, in one embodiment, an electronic data structure such as a database that is stored in the memory 120 or another memory and that is configured with routines that can be executed by the processor(s) 110 for analyzing stored data, providing stored data, organizing stored data, and so on. Thus, in one embodiment, the data store(s) 130 stores data used by the processor(s) 110 in executing various functions. In one embodiment, the data store(s) 130 may include location information 132, vehicle change state information 136, and point of interest (“POI”) information 134.

Location information 132 may include information regarding the location of the vehicle 200 received from the vehicle 200 via a network 400. As will be explained in greater detail later, the vehicle 200 can determine its location, generally to a precision of less than two meters, and provide this position information to the in-vehicle payment centralized server 100. Vehicle change state information 136 can include information received from the vehicle 200 regarding the change of state of any systems or subsystems of the vehicle 200. For example, if the vehicle is placed into park and/or is determined to be at a standstill, this information can be stored as the vehicle change state information 136.

POI information 134 can include the location of certain points of interest. POI information 134 can include a location of a service provider that may be able to provide services to the vehicle 200 and/or the occupant of the vehicle 200. For example, POI information 134 can include the location of numerous points of interest, such as refueling stations, recharging stations, parking lots, restaurants, post offices, etc. Additionally, the POI information 134 can include geo-fenced location information of the particular point of interest as well as specialized location information within the geo-fenced location.

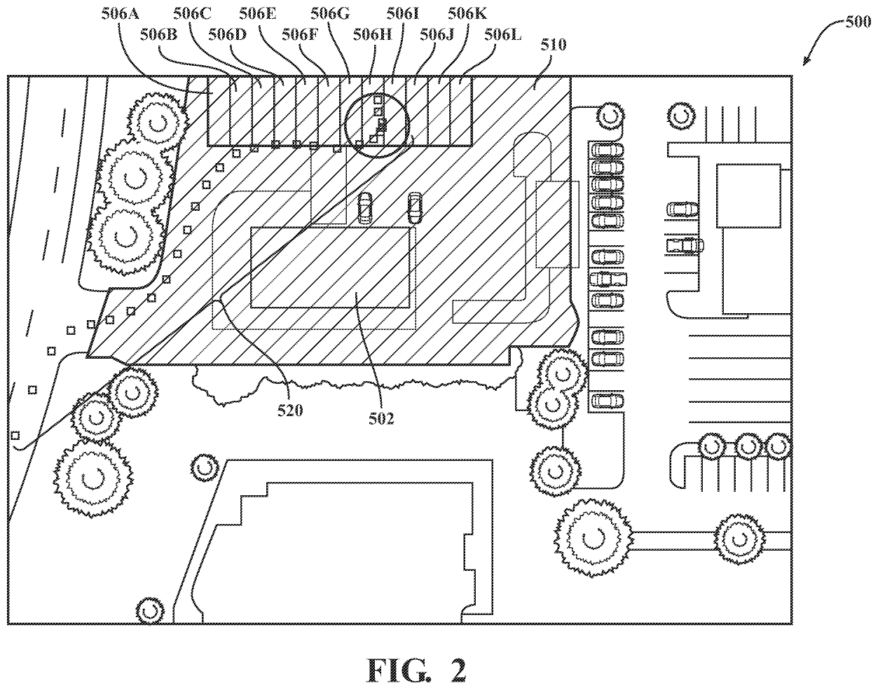

To better visualize the POI information 134, reference is made to FIG. 2, which illustrates an overhead view 500 of a refueling station 502. Here, the refueling station location is indicated by the geo-fenced location 510, which includes the refueling station 502 and the access routes and parking areas. Within the geo-fenced location 510, specialized location information regarding the precise location of specialized locations 506A-506L is also denoted. In this example, specialized locations 506A-506L relate to different fuel pump refueling locations within the refueling station 502. As such, the specialized locations 506A-506L are the locations the vehicle 200 would park when using a particular fuel pump associated with each of the specialized locations 506A-506L.

Turning attention to the vehicle 200 of FIG. 1, a “vehicle” is any form of powered transport. In one or more implementations, the vehicle 200 is an automobile. While arrangements will be described herein with respect to automobiles, it will be understood that embodiments are not limited to automobiles. In some implementations, the vehicle 200 may be any robotic or powered transport device.

The vehicle 200 may include one or more processor(s) 210 that may communicate with various vehicle systems and subsystems via a bus 205, such as a controller area network (“CAN”) bus. However, it should be understood in a type of bus may be utilized. Furthermore, the processor(s) 210 can perform one or more methodologies embodied within the instructions 222 that may be stored within a memory 220 that is in communication with the processor(s) 210. The memory 220 may be similar to the memory 120 and may be any device capable of storing digital information.

The memory 220 may include information that may be utilized by the processor(s) 210 when executing the instructions 222. As such, the memory 220 may include payment information 226, such as account information, routing numbers, credit/debit card credentials, etc. This may be entered into the memory 220 by the occupant of the vehicle 200.

In addition, the memory 220 may include location information 228 and/or vehicle change state information 229, which may be similar to the location information 132 and the vehicle change state information 134. For example, the location information 228 may include the location of the vehicle 200, generally to an accuracy of approximately two meters. The vehicle change state information 229 may include information regarding one or more systems and subsystems of the vehicle 200, such as the speed of the vehicle 200, if the vehicle 200 has been placed in park, or otherwise is at a standstill. Of course, additional information generated by the one or more systems and subsystems of the vehicle 200 can also be stored within the vehicle change state information 229.

The vehicle 200 can also include one or more sensor(s) 230 that can sense one or more states the vehicle 200 and/or the environment surrounding the vehicle 200. The sensor(s) 230 can include any suitable type of sensor. Various examples of different types of sensors will be described herein. However, it will be understood that the embodiments are not limited to the particular sensors described.

The sensor(s) 230 can include one or more vehicle sensors that can detect, determine, and/or sense information about the vehicle 200 itself. In one or more arrangements, the sensor(s) 230 can be configured to detect and/or sense position and orientation changes of the vehicle 200, such as, for example, based on inertial acceleration. In one or more arrangements, the sensor(s) 230 can include one or more accelerometers, wheel speed sensors, gear selection sensors, one or more gyroscopes, an inertial measurement unit (IMU), a dead-reckoning system, and/or other suitable sensors. The vehicle sensor(s) 230 can be configured to detect and/or sense one or more characteristics of the vehicle 200.

Alternatively or additionally, the sensor(s) 230 can include one or more environment sensors configured to acquire and/or sense driving environment data. “Driving environment data” includes data or information about the external environment in which a vehicle is located or one or more portions thereof. For example, the one or more environment sensors can be configured to detect, quantify, and/or sense obstacles in at least a portion of the external environment of the vehicle 200 and/or information/data about such obstacles. Such obstacles may be stationary objects and/or dynamic objects. The sensor(s) 230 can be configured to detect, measure, quantify, and/or sense other things in the external environment of the vehicle 200, for example, lane markers, signs, traffic lights, traffic signs, lane lines, crosswalks, curbs proximate the vehicle 200, off-road objects, etc. Examples of these sensors can include cameras, sonar, radar, light detection and ranging (“LIDAR”) sensors, etc.

The vehicle 200 can also include a global navigation satellite system (GNSS) 232 that uses satellites to provide autonomous geopositioning. The GNSS may be any type of appropriate satellite constellation system, such as a Global Positioning System (“GPS”), Global Navigation Satellite System (“GLONASS”), BeiDou Navigation Satellite System, and Galileo. Generally, the GNSS 232 can determine the location of the vehicle 200 (longitude, latitude, and altitude/elevation) to high precision (within two meters) using time signals transmitted along a line of sight by radio from satellites. In some cases, the vehicle 200 may utilize location information from the GNSS 232 and sensor information, such as heading, from the sensor(s) 230 to create even more accurate vehicle location information. In some cases, the location of the vehicle 200 can be determined accurately, even when the vehicle 200 is traveling to a position of two meters or less. Using this information, it is possible to determine when the vehicle 200 has entered the geo-fence location 510 and/or the specialized locations 506A-506L shown in FIG. 2.

The vehicle 200 can interact with the occupant in a number of different ways. In one example, the vehicle may include a head unit 240 that includes an output device 242 and an input device 244. Generally, the output device 242 is a display, while the input device 244 may be a touchscreen and/or physical controls, such as buttons, knobs, sliders, etc. Also, it should be understood that while the output device 242 and the input device 244 are embodied within a head unit 240, it should be understood that the output device 242 and/or the input device 244 may be embodied in different various forms within the vehicle 200. As such, the output device 242 allows the output of information to the occupant, while the input device 244 allows the occupant to provide input to the vehicle 200.

The vehicle 200 may also include vehicle system(s) 234 that allows the vehicle to function appropriately. As such, the vehicle system(s) 234 can include vehicle powertrain components, braking systems, engines, electric motors, etc. The vehicle 200 may also include a network access device 236 that allows the vehicle to communicate with one or more networks, such as the network 400, to allow the vehicle 200 to communicate with the in-vehicle payment centralized server 100. As such, the network access device 236 includes the appropriate hardware and/or software to allow the vehicle 200, specifically the processor(s) 210 of the vehicle 200, to send and receive information to the in-vehicle payment centralized server 100.

Moving onto the payment facilitator server 300, the payment facilitator server 300 functions to authorize the movement of funds from one account to another. As such, the payment facilitator server 300 generally includes one or more processor(s) 310 in communication with the memory 320 that stores the appropriate instructions 322 that cause the processor(s) 310 to perform this function. While a number of different methodologies may be utilized to facilitate payment, in one example, the transaction can be authorized by sending an authorized payment token to the payment facilitator server 300 server that electronically collects payment under the authorized payment vendor, whereby payment of funds from an issuing bank is processed to an acquiring bank.

As mentioned, FIG. 2 illustrates one example of the overhead view 500 of a scenario wherein the occupant of the vehicle 200 utilizes vehicle payment services. As mentioned before, the overhead view 500 illustrates a refueling station 502. Here, the refueling station location is indicated by the geo-fenced location 510, which includes the refueling station 502 and the access routes and parking areas. Within the geo-fenced location 510, specialized location information regarding the precise location of specialized locations 506A-506L is also denoted. In this example, specialized locations 506A-506L relate to different fuel pump refueling locations within the refueling station 502. As such, the specialized locations 506A-506L are the locations the vehicle 200 would park when using a particular fuel pump associated with each of the specialized locations 506A-506L.

Also illustrated is location information 520, illustrating the location of the vehicle 200 at different points in time. As can be seen, the vehicle enters the geo-fenced location 510 from the left side and proceeds to the specialized region 506H. As such, in this scenario, the vehicle 200 enters the refueling station 502 and parks in an appropriate spot to refuel, as indicated by the location of the vehicle 200 within the specialized region 506H.

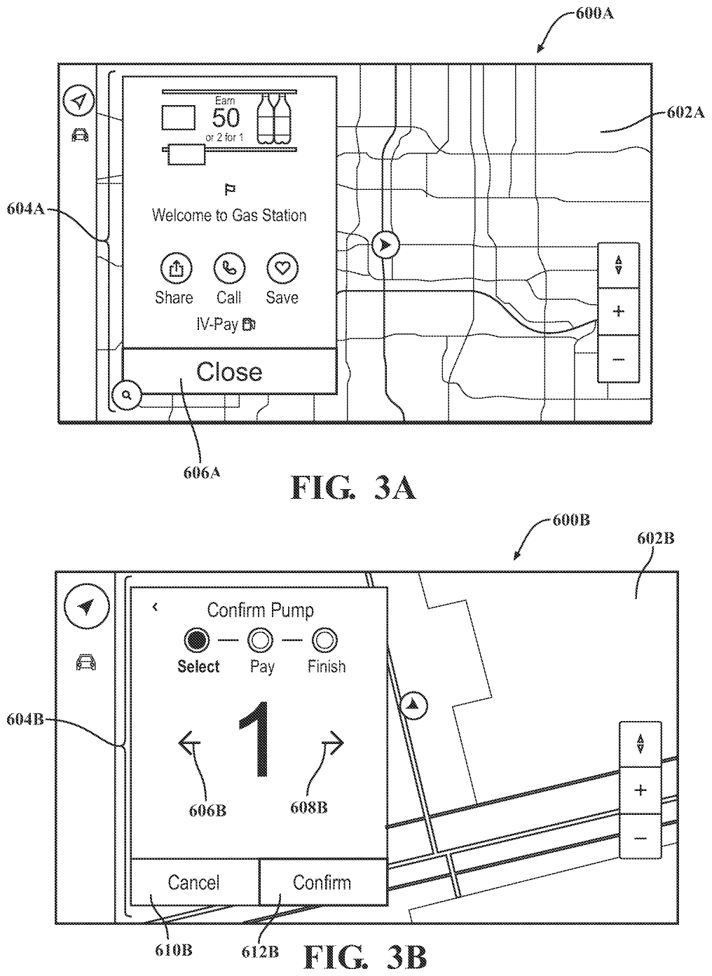

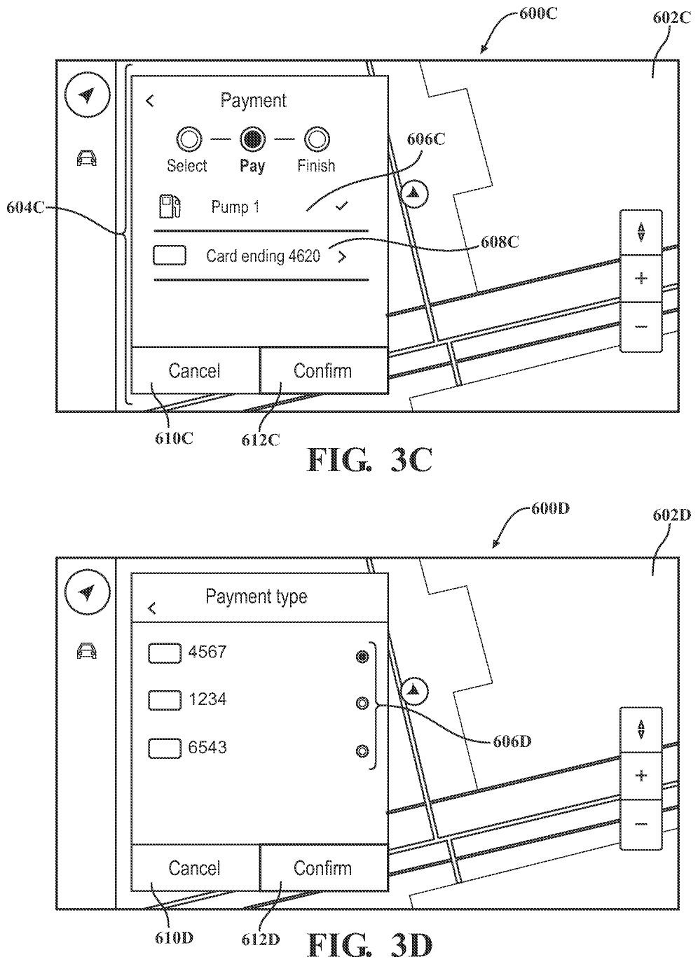

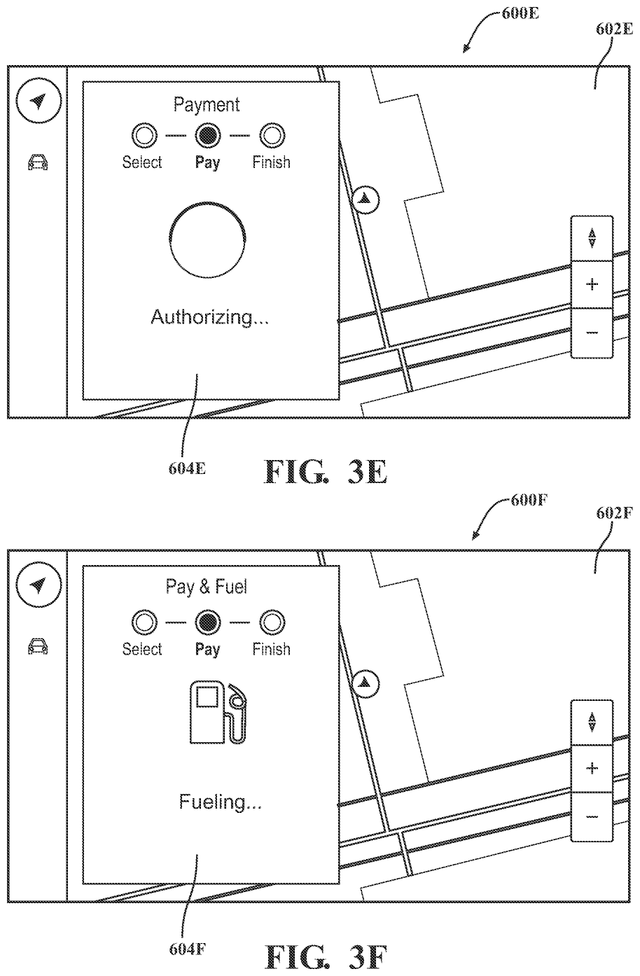

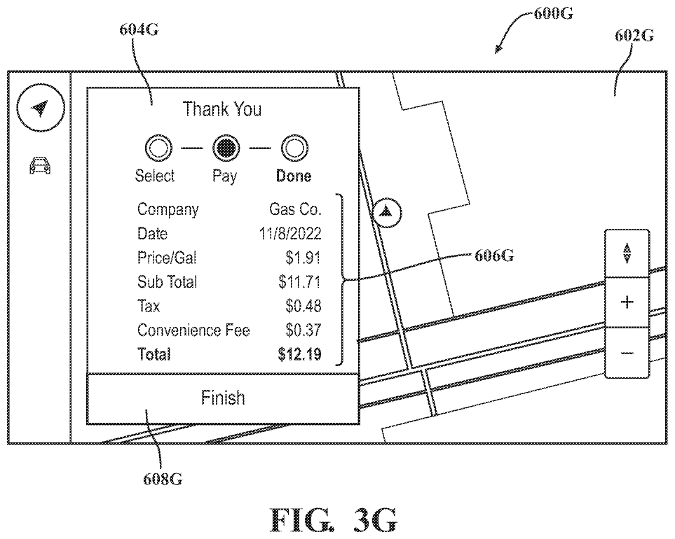

This scenario illustrated in the overhead view 500 of FIG. 2 causes the output device 242 of the head unit 240 of the vehicle 200 and output and receive certain information from the occupant of the vehicle 200. The flow of information and the interfaces displayed by the output device 242 are based on information and instructions received from the in-vehicle payment centralized server 100. Moreover, to better understand this process, reference is made to FIGS. 3A-3G, which illustrate examples of screen captures output by the output device 242, as the in-vehicle payment process unfolds.

The vehicle 200 provides via the network 400 location information to the in-vehicle payment centralized server 100. In some cases, to avoid transmitting unnecessary data, the vehicle 200 may only transmit location information to the in-vehicle payment centralized server 100 based on one or more thresholds, such as the speed of the vehicle 200. For example, if the vehicle 200 is traveling more than 50 mph, it is unlikely that the vehicle 200 will be stopping to receive services. As such, the instructions 222 may cause the processor(s) 210 of the vehicle to only provide location information to the in-vehicle payment centralized server 100 when the vehicle 200 is traveling less than 50 mph or some other threshold amount based on information from the sensor(s) 230, the GNSS 232, or other vehicle system(s) 234.

When the in-vehicle payment centralized server 100 determines that the vehicle 200 has entered a geo-fenced location, such as the geo-fenced location 510 of FIG. 2, the instructions 122 may cause the processor(s) 110 of the in-vehicle payment centralized server 100 to send an instruction to the vehicle 200 and more particularly the processor(s) 210 of the vehicle 200, to display an introduction screen to the occupant of the vehicle 200 using the output device 242. FIG. 3A illustrates a screen capture 600A of the introduction interface 602A. Here, the introduction interface 602A illustrates a welcome screen 604A that may provide some basic identifying information to the occupant of the vehicle 200, such as the name of the establishment associated with the geo-fenced location 510 and even possible sales-related information. The occupant of the vehicle can close this information out by selecting the close button 606A.

The in-vehicle payment centralized server 100 may continue to monitor and receive updated location information from the vehicle 200. The instructions 122 cause the processor(s) 110 to determine when the vehicle 200, using the vehicle location information, has entered a specialized region, such as the specialized region 506H. In this example, the specialized region 506H is a parking location for a particular pump at the refueling station 502. As such, the specialized region 506H is a region that is related to a particular service. In the fuel pump example, this would be the region where the vehicle would park when using a certain fuel pump. In other examples, such as goods delivery, this may be a parking spot identified as where goods should be delivered.

In addition, the instructions 122 cause the processor(s) 110 to determine when the vehicle 200 has had a change in state using a vehicle operating change state signal which may be sent from the vehicle 200 to the in-vehicle payment centralized server 100. As such, the instructions 122 cause the processor(s) 110 to not only determine if the vehicle 200 has entered the specialized region 506H, but also if there has been a change in state in the operation of the vehicle 200, such as the vehicle 200 being placed into park. More simply, the in-vehicle payment centralized server 100 receives location information to determine if the vehicle 200 is in front of the pump and if the vehicle 200 has entered into a park state. Using both metrics, the in-vehicle payment centralized server 100 can correctly determine if the occupant desires to refuel their vehicle. Of course, other vehicle state information can be utilized, such as the speed of the vehicle, if the vehicle has been turned on/off, etc. Upon making this determination, the instructions 122 cause the processor(s) 110 to send an instruction to the processor(s) 210 of the vehicle 200 to display a location confirmation interface so that the occupant can confirm the location of the vehicle 200.

An example of the location confirmation interface is shown in FIG. 3B in screen capture 600B. Here, the interface 602B includes a display area 604B that illustrates the pump number as well as input arrows 606B and 608B that allow the occupant to change the pump number in the situation that the appropriate pump number is not being shown in the display area 604B. Generally, the pump number should be correct as it can be related to the specialized region 506H. For example, the POI information 136 can include pump numbers associated with each specialized region 506A-506L. For example, specialized region 506A could relate to pump five, while 506H could relate to pump one. Using this information, the interface 602B would display the pump related to that particular specialized region. However, to ensure this is correct, the interface 602B allows the occupant to confirm. If the pump number is correct or the occupant has adjusted the pump number to become correct, the occupant can confirm the location by pressing the confirm button 612B. Additionally, if the occupant decides they do not want any related services, they can cancel by selecting the cancel button 610B.

Confirming the location by the occupant causes the processor(s) 210 of the vehicle 200 to send a signal indicating that the occupant has confirmed the location of the vehicle 200 to the in-vehicle payment centralized server 100. Upon receiving the signal, the instructions 122 cause the processor(s) 110 of the in-vehicle payment centralized server to send a signal to the processor(s) 210 of the vehicle 200 to display a payment confirmation interface to the occupant using the output device 242.

An example of the payment confirmation interface is shown in the screen capture 600C of FIG. 3C. Here, the interface 602C includes a display area 604C that shows a pump identifier 606C and a credit card identifier 608C that may be used for payment. Here, the occupant can select to cancel the transaction by selecting the cancel button 610C or can authorize the transaction by selecting the authorize button 612C. Alternatively, the interface 602C also allows the occupant to select another form of payment by selecting the credit card identifier 608C. When this occurs, another interface 602D, shown in screen capture 600D of FIG. 3D, is displayed to the occupant. Here, the occupant can select other payment options 606D. After selecting the appropriate payment option, the occupant can either cancel the selection by selecting the button 610D or can confirm the selection by engaging the select button 612D.

Once the occupant has authorized the payment, the instructions 222 cause the processor(s) 210 of the vehicle 200 to send to the in-vehicle payment centralized server 100 a payment authorization signal, indicating that the occupant has authorized payment. When this occurs, the instructions 122 cause the processor(s) 110 of the in-vehicle payment centralized server 100 to initiate the payment facilitator server 300, which electronically collects payment under an authorized payment vendor. During this authorization process, the output device 242 may display an authorization screen 604E shown in the screen capture 600E of the interface 602E of FIG. 3E.

Once payment is authorized, an indication may be provided to the occupant that they can engage in services, such as refueling the vehicle 200. FIG. 3F illustrates an example screen capture 600F of an interface 602F that includes a display area 604F that indicates to the occupant they may engage in appealing their vehicle. Once the occupant is no longer refueling their vehicle, the occupant may be provided with details regarding their purchase. For example, FIG. 3G illustrates a screen capture 600G of an interface 602G that includes a display area 604G that includes details 606G of the purchase, such as the name of the merchant, date, price, subtotal, tax, convenience fee, and a total. The interface 602G can be closed out by pressing the finish button 608G.

It should be understood that the example given regarding the refueling of the vehicle 200 is just one example that may utilize the in-vehicle payment services described in this description. Other services can also take advantage of this in-vehicle payment service. For example, instead of reviewing the vehicle, the vehicle could be recharged at a battery recharging station, receive parking services at a parking lot, pick up goods, such as food or other items, at a delivery location, and the like. The number of applications that can take advantage of the vehicle payment services described in this description are numerous and should not be limited to just those described.

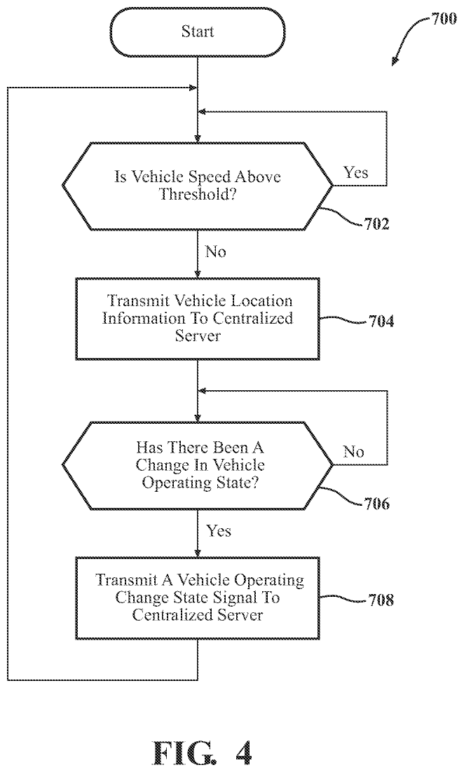

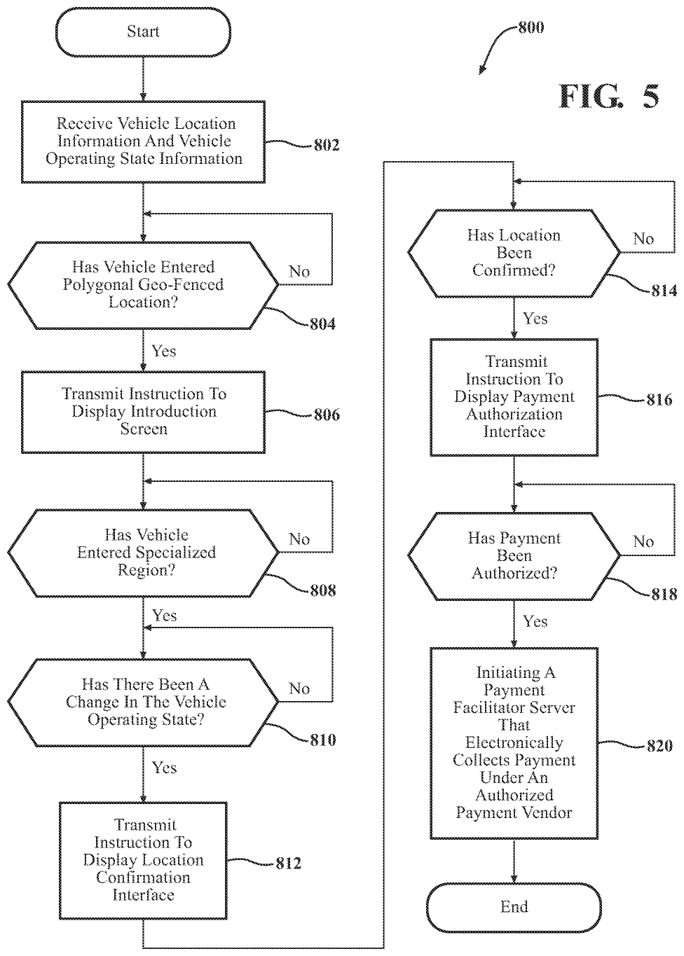

FIGS. 4 and 5 illustrate various methods that may be utilized when providing in-vehicle payment services. Referring to FIG. 4, a method 700 for providing vehicle information from a vehicle, such as the vehicle 200, to a centralized server, such as the in-vehicle payment centralized server 100, is shown. The method 700 will be described from the viewpoint of the vehicle 200. However, it should be understood that this is just one example of implementing the method 700. While method 700 is discussed in combination with the vehicle 200, it should be appreciated that the method 700 is not limited to being implemented within the vehicle 200, but is instead one example of a system that may implement the method 700.

As mentioned before, there may be situations where it is advisable to only transmit information from the vehicle 200 to the in-vehicle payment centralized server 100 when the information is deemed useful. For example, if the vehicle 200 is traveling at a great rate of speed on the highway, it is unlikely that the vehicle will need to perform any in-vehicle payment activities. However, when the vehicle 200 is traveling at slower speeds, the likelihood that the systems and methods related to in-vehicle payment activities should increase.

Broadly, the method 700 transmits information from the vehicle when satisfying a speed-related threshold. The method 700 begins with step 702, wherein the instructions 222, when executed by the processor(s) 210 of the vehicle 200, causes the processor(s) 210 to determine if the vehicle speed of the vehicle 200 is above a threshold. This may be achieved by utilizing information from the sensor(s) 230, the GNSS 232, and/or the vehicle system(s) 234 to determine the overall speed of the vehicle 200 by the processor(s) 210. Once the overall speed of the vehicle 200 is determined, this speed can be compared to a threshold speed. In one example, the threshold speed may be 50 mph, wherein the method 700 will proceed to step 704 if the vehicle 200 is traveling below the threshold speed but will return to the beginning of the method 700 if the vehicle 200 is traveling above the threshold speed. Additionally, it should be understood that the threshold speed of 50 mph is merely an example of the threshold speed. Threshold speed may vary considerably from application to application.

In step 704, the instructions 222, when executed by the processor(s) 210 of the vehicle 200, causes the processor(s) 210 to transmit vehicle location information to the in-vehicle payment centralized server 100. The vehicle location information generally includes information regarding the location of the vehicle 200 and can be based on a number of different data sources from within the vehicle 200, such as location information from the GNSS 232 and other information from the sensor(s) 230, such as heading information, orientation, etc.

In step 706, the instructions 222, when executed by the processor(s) 210 of the vehicle 200, causes the processor(s) 210 to determine if there has been a change in vehicle operating state of the vehicle 200. This may be achieved based on information from the sensor(s) 230 and/or the vehicle system(s) 234. For example, the vehicle system(s) 234 may output a signal to the bus 205 indicating that the transmission has been placed into park. When this occurs, the processor(s) 210 determines that there has been a change in vehicle state and provides this information to the in-vehicle payment centralized server 100, as indicated in step 708. Otherwise, the method 700 continues to monitor for a change in the vehicle operating state.

It should be noted that the change in vehicle operating state information that is transmitted to the in-vehicle payment centralized server 100 can include any information about the vehicle 200. For example, other information may include but is not limited to, the vehicle's speed, engagement of the parking brake, if the vehicle 200 is at a standstill, if the vehicle 200 has been turned on/off, etc. Once the change in vehicle state has been transmitted to the in-vehicle payment centralized server 100, the method 700 may end or return to the beginning as shown.

Referring to FIG. 5, a method 800 for enabling in-vehicle payments is illustrated from the perspective of the actions taken by the in-vehicle payment centralized server 100. The method 800 will be described from the viewpoint of the in-vehicle payment centralized server 100. However, it should be understood that this is just one example of implementing the method 800. While method 800 is discussed in combination with the in-vehicle payment centralized server 100, it should be appreciated that the method 800 is not limited to being implemented within the in-vehicle payment centralized server 100, but is instead one example of a system that may implement the method 800.

In step 802, the instructions 122, when executed by the processor(s) 110 of the in-vehicle payment centralized server 100, causes the processor(s) 110 to receive vehicle location information and vehicle operating state information from the vehicle 200. The vehicle 200 may provide this information periodically or based on satisfying some threshold, as described and shown in the method 700 of FIG. 5. The vehicle location information generally provides the location of the vehicle having an accuracy of approximately two meters or less. However, it should be understood that more or less accurate location information could also be provided. The vehicle operating state information can include any information about the vehicle 200, such as if the vehicle has been placed into park, engagement of the parking brake, if the vehicle is at a standstill, if the vehicle has been turned on/off, speed of the vehicle, etc.

In step 804, the instructions 122, when executed by the processor(s) 110 of the in-vehicle payment centralized server 100, cause the processor(s) 110 to determine if the vehicle 200 has entered a geo-fenced location. Moreover, using the vehicle location information and the POI information 136, the processor(s) 110 can determine if the vehicle has entered a particular geo-fenced location. If the vehicle 200 has entered a geo-fenced location, the method 800 continues to step 806. Otherwise, the processor(s) 110 continues to monitor for a situation where the vehicle 200 enters a geo-fenced location.

In step 806, the instructions 122, when executed by the processor(s) 110 of the in-vehicle payment centralized server 100, cause the processor(s) 110 to transmit an instruction to display an introduction screen to the vehicle 200. An example of the introduction screen is shown in FIG. 3A and described in the prior paragraphs. Generally, the introduction screen may provide some basic identifying information to the occupant of the vehicle 200, such as the name of the establishment associated with the geo-fenced location 510 and even possible sales-related information.

In step 808, the instructions 122, when executed by the processor(s) 110 of the in-vehicle payment centralized server 100, cause the processor(s) 110 to determine if the vehicle 200 has entered a specialized region. The specialized region is a region that is related to a particular service. If the specialized region relates to a fuel pump, this would be the region where the vehicle would park when using a certain fuel pump. In other examples, such as goods delivery, this may be a parking spot identified as where goods should be delivered. If the vehicle 200 has entered the specialized region, the method 800 continues to step 810. Otherwise, the processor(s) 110 continues to monitor for a situation where the vehicle 200 enters a specialized region.

In step 810, the instructions 122, when executed by the processor(s) 110 of the in-vehicle payment centralized server 100, cause the processor(s) 110 to determine if the vehicle 200 has undergone an appropriate change in the operating state, indicating that the occupant of the vehicle 200 may be wanting to obtain services at the specialized region. For example, suppose the vehicle 200 provides a change in operating state that indicates that the vehicle 200 has been placed in park, engaged the parking brake, is at a standstill, or has been turned off. In that case, this condition may be satisfied, and the method 800 will proceed to step 812. Otherwise, the processor(s) 110 continues to monitor for an appropriate change in the operating state of the vehicle 200.

In step 812, the instructions 122, when executed by the processor(s) 110 of the in-vehicle payment centralized server 100, cause the processor(s) 110 to transmit an instruction to the vehicle 200 to display a location confirmation interface. As mentioned, the location confirmation interface allows the occupant to confirm the location of the vehicle 200 with respect to the specialized region. For example, if the specialized region relates to a specific fuel pump number, the location confirmation interface will display that fuel pump number and allow the occupant to confirm this information or change this information if there is a location error.

In step 814, the instructions 122, when executed by the processor(s) 110 of the in-vehicle payment centralized server 100, cause the processor(s) 110 to determine if the location has been confirmed. Moreover, the processor(s) 110 monitors for a signal from the vehicle 200 confirming the location of the vehicle 200 with respect to the specialized region. If the vehicle location has been confirmed, the method 800 continues to step 816. Otherwise, the processor(s) 110 continues to monitor for confirmation.

In step 816, the instructions 122, when executed by the processor(s) 110 of the in-vehicle payment centralized server 100, cause the processor(s) 110 to send a signal to the processor(s) 210 of the vehicle 200 to display a payment confirmation interface to the occupant using the output device 242. As previously described, the payment confirmation interface allows the occupant of the vehicle 200 to confirm and/or change payment of services associated with the specialized region. In the refueling example, this could involve authorizing payment for fuel using a credit card.

In step 818, the instructions 122, when executed by the processor(s) 110 of the in-vehicle payment centralized server 100, cause the processor(s) 110 to determine if the occupant of the vehicle 200 has authorized payment. Moreover, the processor(s) 110 determine if a payment authorization signal has been received, indicating that the occupant has authorized payment. If payment has been authorized, the method 800 continues to step 820. Otherwise, the processor(s) 110 continues to monitor for authorization.

In step 818, the instructions 122, when executed by the processor(s) 110 of the in-vehicle payment centralized server 100, cause the processor(s) 110 to initiate the payment facilitator server 300, which electronically collects payment under an authorized payment vendor. After that, the method 800 may end or start from the beginning.

Detailed embodiments are disclosed herein. However, it is to be understood that the disclosed embodiments are intended only as examples. Therefore, specific structural and functional details disclosed herein are not to be interpreted as limiting but merely as a basis for the claims and as a representative basis for teaching one skilled in the art to variously employ the aspects herein in virtually any appropriately detailed structure. Further, the terms and phrases used herein are not intended to be limiting but to provide an understandable description of possible implementations. Various embodiments are shown in the figures, but the embodiments are not limited to the illustrated structure or application.

The flowcharts and block diagrams in the figures illustrate the architecture, functionality, and operation of possible implementations of systems, methods, and computer program products according to various embodiments. Each block in the flowcharts or block diagrams may represent a module, segment, or portion of code comprising one or more executable instructions for implementing the specified logical function(s). It should also be noted that, in some alternative implementations, the functions noted in the block may occur out of the order noted in the figures. For example, two blocks shown in succession may be executed substantially concurrently, or the blocks may sometimes be executed in the reverse order, depending upon the functionality involved.

The systems, components, and/or processes described above can be realized in hardware or a combination of hardware and software. They can be realized in a centralized fashion in one processing system or in a distributed fashion where different elements are spread across several interconnected processing systems. Any processing system or apparatus adapted for the methods described herein is suited. A typical combination of hardware and software can be a processing system with computer-usable program code that, when being loaded and executed, controls the processing system such that it carries out the methods described herein. The systems, components, and/or processes also can be embedded in computer-readable storage, such as a computer program product or other data programs storage device, readable by a machine, tangibly embodying a program of instructions executable by the machine to perform methods and processes described herein. These elements also can be embedded in an application product that comprises all the features enabling the implementation of the methods described herein and which, when loaded in a processing system, can carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, device, or any suitable combination of the preceding. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the preceding. In the context of this document, a computer-readable storage medium may be any tangible medium that can contain or store a program for use by or in connection with an instruction execution system, apparatus, or device.

Program code embodied on a computer-readable medium may be transmitted using any appropriate medium, including but not limited to wireless, wireline, optical fiber, cable, RF. etc., or any suitable combination of the preceding. Computer program code for carrying out operations for aspects of the present arrangements may be written in any combination of one or more programming languages, including an object-oriented programming language such as Java™M. Smalltalk, C++, or the like, and conventional procedural programming languages, such as the “C” programming language or similar programming languages. The program code may execute entirely on the user's computer, partly on the user's computer, as a stand-alone software package, partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another.” as used herein, is defined as at least a second or more. The terms “including” and/or “having.” as used herein, are defined as comprising (i.e., open language). The phrase “at least one of . . . and . . . ” as used herein refers to and encompasses any and all possible combinations of one or more of the associated listed items. For example, the phrase “at least one of A, B, and C” includes A only, B only, C only, or any combination thereof (e.g., AB, AC, BC, or ABC).

Aspects can be embodied in other forms without departing from the spirit or essential attributes. Accordingly, reference should be made to the following claims rather than the preceding specification, indicating the scope.

What is claimed is:

1. A system comprising:
a processor; and
a memory in communication with the processor, the memory having instructions that, when executed by the processor, cause the processor to:
in response to determining when a vehicle enters a specialized region within a geo-fenced location and a vehicle operating change state signal from the vehicle, transmit a first instruction to provide a location confirmation interface for utilization by an occupant of the vehicle, and
in response to a location confirmation signal indicating that the occupant has confirmed a location of the vehicle using the location confirmation interface, transmit a second instruction to provide a payment confirmation interface for utilization by the occupant of the vehicle.

2. The system of claim 1, wherein the memory further includes instructions that, when executed by the processor, cause the processor to:
in response to determining when the vehicle enters the geo-fenced location, transmit an instruction to display an introduction screen to the occupant of the vehicle using a display device of the vehicle.

3. The system of claim 1, wherein the memory further includes instructions that, when executed by the processor, cause the processor to:
in response to receiving a payment authorization from the vehicle indicating that the occupant has authorized payment using the payment confirmation interface, initiating a payment facilitator server that electronically collects payment under an authorized payment vendor.

4. The system of claim 1, wherein the memory further includes instructions that, when executed by the processor, cause the processor to receive a vehicle location signal from the vehicle.

5. The system of claim 4, wherein the vehicle location signal from the vehicle is transmitted from the vehicle at a frequency that is based on a speed of the vehicle.

6. The system of claim 1, wherein the vehicle operating change state signal indicates that a gear selector of the vehicle has been placed into park.

7. The system of claim 1, wherein the vehicle operating change state signal indicates that the vehicle is not moving.

8. The system of claim 1, wherein the geo-fenced location relates to a location of a service provider and the specialized region within the geo-fenced location relates to a location where services provided by the service provided are to be performed.

9. The system of claim 8, wherein the services include one or more of refueling services for refueling the vehicle, goods delivery services for providing goods to the occupant of the vehicle, and battery charging services for recharging a battery of the vehicle.

10. A method comprising steps of:
in response to determining when a vehicle enters a specialized region within a geo-fenced location and a vehicle operating change state signal, transmitting a first instruction to provide a location confirmation interface for utilization by an occupant of the vehicle; and
in response to a location confirmation signal indicating that the occupant has confirmed a location of the vehicle using the location confirmation interface, transmitting a second instruction to provide a payment confirmation interface for utilization by the occupant of the vehicle.

11. The method of claim 10, further comprising the step of:
in response to determining when the vehicle enters the geo-fenced location, transmitting an instruction to display an introduction screen to the occupant of the vehicle using a display device of the vehicle.

12. The method of claim 10, further comprising the step of:
in response to receiving a payment authorization from the vehicle indicating that the occupant has authorized payment using the payment confirmation interface, initiating a call to a backend service to authorize a transaction that sends an authorized payment token from the vehicle to a payment facilitator server that electronically collects payment under an authorized payment vendor.

13. The method of claim 10, further comprising the step of receiving a vehicle location signal from the vehicle.

14. The method of claim 13, wherein the vehicle location signal from the vehicle is transmitted from the vehicle at a frequency that is based on a speed of the vehicle.

15. The method of claim 10, wherein the vehicle operating state change signal indicates that a gear selector of the vehicle has been placed into park.

16. The method of claim 10, wherein the vehicle operating change state signal indicates that the vehicle is not moving.

17. The method of claim 10, wherein the geo-fenced location relates to a location of a service provider and the specialized region within the geo-fenced location relates to a location where services provided by the service provided are to be performed.

18. The method of claim 17, wherein the services include one or more of refueling services for refueling the vehicle, goods delivery services for providing goods to the occupant of the vehicle, battery charging services for recharging a battery of the vehicle, and parking services for allowing the vehicle to park in a parking lot.

19. A non-transitory computer-readable medium including instructions that, when executed by a processor, cause the processor to:
in response to determining when a vehicle enters a specialized region within a geo-fenced location and a vehicle operating change state signal, transmit a first instruction to provide a location confirmation interface for utilization by an occupant of the vehicle; and
in response to a location confirmation signal indicating that the occupant has confirmed a location of the vehicle using the location confirmation interface, transmit a second instruction to provide a payment confirmation interface for utilization by the occupant of the vehicle.

20. The non-transitory computer-readable medium of claim 19, further including instructions that, when executed by the processor, cause the processor to:
in response to receiving a payment authorization from the vehicle indicating that the occupant has authorized payment using the payment confirmation interface, initiating a call to a backend service to authorize a transaction that sends an authorized payment token from the vehicle to a payment facilitator server that electronically collects payment under an authorized payment vendor.
